(19) United States
(12) Patent Application Publication
(10) Pub. No.: US 2003/0144829 A1
(43) Pub. Date: Jul. 31, 2003

(54) System and method for sensing and evaluating physiological parameters and modeling an adaptable predictive analysis for symptoms management

(76) Inventors: Michael W. Geatz, Maple Groove, MN (US); Richard J. Roiger, Mankato, MN (US)

Correspondence Address: Stuart R. Hemphill, DORSEY & WHITNEY LLP, Intellectual Property Department, 50 South Sixth Street, Suite 1500, Minneapolis, MN, 55402-1498, US

(21) Appl. No.: 10/350,701

(22) Filed: Jan. 24, 2003

Related U.S. Application Data
(60) Provisional application No. 60/351,575, filed on Jan. 25, 2002.

(51) Int. Cl. G06F 9/45

(52) U.S. Cl. 703/22

(57) ABSTRACT

A system senses various physiological parameters of a patient such as heart rate or temperature to evaluate the patient and predict when an episode of a chronic symptom may occur. The system further includes a modeling component which generates an individualized predictive model for a given patient wherein the patient's previous episodes of the symptom are utilized to shape the model. The system tests the model to assure accuracy and can revise the model as necessary. Once the model is established, the system monitors patient parameters and can alert the patient to the expected onset of the symptom and/or automatically administer an appropriate drug or other therapy to control the expected symptom. The system is applicable to allergic reactions, anxiety attacks, attention deficit hyperactivity disorders, backaches, depression, dizziness, drowsiness, epileptic seizures, fatigue, heart malfunction, hunger pangs, joint or other pain, loss of motor control, migraines, motion sickness, muscle spasm, nausea, nicotine fits, numbness, shaking, shortness of breath, sleep or sleep disorders, tremors, unconsciousness, vision impairment or other chronic symptoms.

### CROSS-REFERENCE TO RELATED APPLICATION(S)

This patent application claims priority from provisional patent application No. 60/351,575, filed Jan. 25, 2002.

### BACKGROUND OF THE INVENTION

This invention relates generally to medical devices, and more specifically to a method and apparatus for sensing and reacting to patient physiological data.

Many people suffer from chronic or recurring symptoms or various other unpleasant or disturbing indications caused by a wide variety of medical ailments. Some possibilities include: allergic reactions, anxiety attacks, attention deficit hyperactivity disorders, backaches, depression, dizziness, drowsiness, epileptic seizures, fatigue, heart malfunction, hunger pangs, joint or other pain, loss of motor control, migraines, motion sickness, muscle spasm, nausea, nicotine “fit”, numbness, shaking, shortness of breath, sleep or sleep disorders, tremors, unconsciousness, and vision impairment. In fact, approximately 1 in 5 people suffer from some sort of chronic acute symptoms during their lifetime. Understandably, these people desire and seek relief from the medical community. A typical patient suffering from such chronic symptoms might spend anywhere from $500 to $35,000 annually to treat or minimize their symptoms. Treatments for symptoms involve various drug and/or physical therapies, chiropractic care, acupuncture, meditation and yoga.

People who utilize drug therapies to alleviate their symptoms currently have two choices. They can wait until the onset of symptoms before receiving the appropriate drugs. Alternatively, chronic sufferers can subject their bodies to medication or subject themselves to other therapies on a continual or scheduled basis. Likewise, those who utilize various physical therapies can wait until the onset of actual symptoms, or can engage in those therapies that might prevent the onset of subsequent symptoms on some scheduled basis.

Neither alternative is particularly appealing to chronic symptom sufferers for whom drug therapy is necessary. That is, patents who wait until the onset of symptoms necessarily endure a period of discomfort or difficulty while they wait for the drug therapy to take effect. Those who subject themselves continuously to medication may suffer the often serious side effects of continuous or too frequent drug therapy. The particular side effects will, of course, depend upon the specific drug therapies being utilized.

Various devices or sensors exist to collect physiological data regarding a given patient. That is, a patient's current physical condition can, to some extent, be objectively measured. For example, a person's temperature can be taken or their heart rate measured. Some devices already exist that can be worn or carried by the patient to collect data over a period of time. For example, the “Mini Logger” manufactured by Mini Mitter of Bend, Oreg. can measure up to five parameters including temperatures from different locations, movement/activity levels, or heart rate. These devices simply collect the data but do not utilize or interpret the data, nor do they respond to conditions indicated by the data.

### BRIEF SUMMARY OF THE INVENTION

The present invention is, in one embodiment, a body-worn sensor unit capable of predicting the onset of a chronic symptom in a person and alerting the person to the possible onset of the chronic symptom and/or automatically administering an appropriate drug or other therapy. The sensor unit monitors various physiological characteristics of the patient and provides data to stored predictive models. When certain parameter values or patterns are observed, the sensor unit indicates the onset of symptoms and may initiate the appropriate action. The sensor unit learns what physiological data indicate the chronic symptom or the onset of the chronic symptom through patient input and data analysis or modeling.

In another embodiment, a data agent is provided in the form of a sensor that is worn about the wrist to monitor various physiological parameters such as temperature, heart rate, blood pressure, blood oxygen level, patient movement, cardiac pacing, cardiac rhythm (ECG), or various other parameters.

In another embodiment, the data agent communicates with a modeling agent that obtains test data from a patient utilizing the data agent to establish a baseline for predictive modeling of symptom onset. The data agent records various physiological parameters and also records indications by the patient of the patient-perceived onset of the symptom. After an appropriate amount of data is recorded, a predictive model may be established. In one embodiment, the modeling agent utilizes a neural network architecture to generate and test a predictive model.

In another embodiment, a network testing protocol is established to test the system after a predictive model has been established. The data agent obtains various physiological parameters from the patient and this data is fed to the system. The system monitors the data and, when appropriate, makes a predictive symptom analysis. In addition, the patient continues to manually enter data indicating the patient-perceived onset of the symptom. The system then evaluates the predictive success of the system. If successful, the system is allowed to proceed to the next level of use. If unsuccessful, the system incorporates the newly obtained data and reconstructs the model for the patient. In this manner, the system individualizes or learns patient specific parameters that indicate the onset of the symptom.

In another embodiment, a controller agent is provided to respond to an analysis predicting the onset of a symptom. The controller agent can respond in a number of ways. The controller agent can indicate the predictive analysis directly to the patient (or to a medical care giver observing the patient) through an audible or visual indicator, such as, for example, a flashing light, or generated tone or beep. The controller could also be coupled with a drug therapy delivery device, such as a transdermal patch or other delivery method that can be automatically actuated by the controller agent to automatically deliver a drug therapy. Thus, the patient can receive the appropriate drug therapy automatically, before the onset of the symptom without suffering the consequences of being continually (and unnecessarily) subjected to medication.

In another embodiment, the data agent can transmit collected data to a third party monitoring the patient for purposes of symptoms management. For example, the collected and analyzed data regarding a patient can be sent to a system coordinated with that patient's doctor or caregiver. The doctor can then utilize the acquired data set (which may be continuous and real-time) to evaluate the patient. In some cases, the patient may be under the doctor's direct care, i.e., staying in a hospital, and the data obtained can be used for symptom management purposes.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a block diagram of a patient monitoring and predictive analysis system, consistent with the principles of the present invention.

FIG. 2 is flowchart indicating an overview of the operation of the system of FIG. 1.

FIG. 3 is a flowchart indicating the process of data collection.

FIG. 4 is a flowchart indicating the process of network architecture training.

FIG. 5 is a flowchart indicating the process of network testing.

FIG. 6 is a flowchart indicating the process of application modeling.

FIG. 7 is a system diagram of the system of FIG. 1

FIG. 8 illustrates the weighting values given to various sensory input parameter.

FIG. 9 is a system diagram indicating the process of network testing.

FIG. 10 is a system diagram indicating the process of actions taken by a controller agent.

### DETAILED DESCRIPTION

A. Overview of Components

The following embodiments are described in reference to a device that monitors certain physiological parameters to predict when a symptom will ensue and to initiate an appropriate action. The present invention can be utilized to monitor any physiological parameter relevant to predict the onset or occurrence of various symptoms or indications and to initiate appropriate action based on those symptoms or indications. Such actions may include the delivery of a drug or other therapy (e.g., electrostimulation) or may include alerting the patient. Symptoms or indications may include, but are not limited to: allergic reactions, anxiety attacks, attention deficit hyperactivity disorders, backaches, depression, dizziness, drowsiness, epileptic seizures, fatigue, heart malfunction, hunger pangs, joint or other pain, loss of motor control, migraines, motion sickness, muscle spasm, nausea, nicotine “fit”, numbness, shaking, shortness of breath, sleep or sleep disorders, tremors, unconsciousness, and vision impairment.

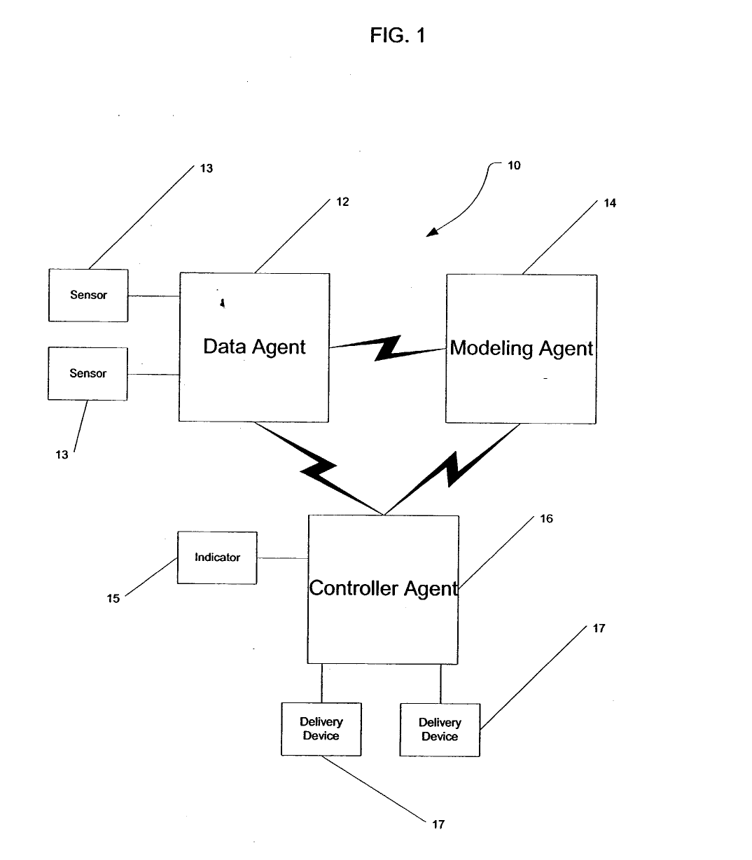

FIG. 1 is a block diagram of a patient monitoring and analysis system 10. The system 10 includes components that perform various functions and these components can be integrated into a single device or split among any number of separate or different devices that can communicate with one another as required. System 10 includes a data agent 12, a modeling agent 14 and a controller agent 16.

Data agent 12 is a component that receives data from a patient indicating various physiological parameters. For example, data agent 12 may be worn on the body by the patient and include one or more sensors 13 for measuring physiological parameters. In one embodiment, data agent 12 is worn about the wrist and includes sensors 13 (and/or interfaces for external sensors) for measuring temperature, physical activity (i.e., patient movement, including myoelectric signals), heart rate, cardiac rhythm (ECG), blood pressure, blood oxygen levels, breath sounds, skin moisture levels, brain wave activity (EEG) or various other parameters. Of course, while data agent 12 may be worn about the wrist (or located elsewhere) various individual sensors 13 can be placed remotely from data agent 12 while communicating data back to data agent 12. In addition to patient specific parameters (patient state data), data agent 12 can also sense various external parameters that might affect a patient, such as weather conditions including barometric pressure, temperature, humidity, light levels, or other factors (external state data).

Various types and configurations of sensors 13 can be employed by data agent 12 to measure physiological components. For example, a thermistor can be utilized to measure temperature. Various types of sensors can be utilized to measure the patient's pulse rate. In one embodiment, a piezoresistive film can be applied with a slight amount of pressure against an artery. In another embodiment, a second piezoresistive film is positioned near but not against the artery and the outputs of the first and second piezoresistive films are subtracted from one another to reduce or eliminate noise. Significant noise may be generated through normal patient movement. In another embodiment, a pressure transducer can be utilized. In another embodiment, a piezoresistive film is positioned near but not against the artery and the outputs of the pressure transducer and piezoresistive film are subtracted from one another to reduce or eliminate noise. In another embodiment, a condenser microphone can be utilized to register audible signals representative of the heart rate. In another embodiment, a laser or laser-like emitter (using infrared or other frequency range that safely reaches blood vessels) can be utilized to measure refractive characteristics of blood flows. To monitor patient movement or activity, one or more accelerometers (three-axis will allow for complete three dimensional measurements) may be provided. The sensors collect data on two or more parameters of patient state data that are understood to have predictive value for the onset of a symptom that is intermittent and often chronic.

Data agent 12 may also register direct patient perception input provided by the patient when the patient experiences the onset of a symptom. This allows system 10 to develop a baseline of sensed data that is correlated to the actual onset of symptoms as subjectively reported by the patient. The patient input can be limited to a single instance type. That is, the patient simply presses a button or otherwise actuates the device when a particular symptom occurs. Alternatively, multiple inputs for symptom progression data could be provided. For example, one indication could be made when the patient believes symptoms will ensue, another when symptoms begin, another, when the symptoms intensify, another when symptoms reach a perceived maximum, and another when the symptoms subside. Likewise, the patient could indicate the onset of symptoms and at various times, indicate the level of intensity by, for example, entering a value on a scale of 1-10. (Where an observer of the patient can report onset of the symptoms, that data may be used with or in place of patient-reported data.) Thus, various patient inputs relating to the patient's experience of the onset and intensity of the symptoms can be recorded.

Broadly, modeling agent 14 develops a protocol by which system 10 interprets the data received by data agent 12 and makes a predictive determination as to the onset of symptoms. In one embodiment, modeling agent 14 trains a neural network model that becomes able to predict the onset of symptoms associated with the patient's affliction. A neural network is a set of interconnected nodes designed to imitate the functioning of the human brain. Modeling agent 14 may include a multi-layer, fully connected, feed forward neural network. In a fully connected neural network, the nodes at one layer are connected to all of the nodes at the next layer. Each network node connection has an associated weight. While training the neural network, data passes through the network and the weights change so as to better predict the patient's condition (i.e., symptom discomfort/no discomfort) associated with each data reading. Any data errors given as discrepancies in the patient's condition between actual and network computed values are propagated back through the network by changing connection weight values. Training will terminate after a certain number of iterations or when the network converges to a predetermined minimum error rate. One concern, is the possibility of local rather than global network convergence. To avoid this, several iterations of neural network training with alternative initial parameters settings may be necessary to achieve the best result. Because network training is an external process, multiple training iterations do not adversely affect or involve the patient. (For further discussion of neural network training techniques to produce a trained neural network, see R. Roiger and M. Geatz, Data Mining—A Tutorial Based Primer (Addison Wesley 2003) and references cited therein.)

Modeling agent 14 could utilize other modeling protocols instead of a neural network. For example, modeling agent 14 could be based on an evolutionary (also called genetic) algorithm utilizing a natural selection process to achieve effective predictive results.

In dealing with patient indications or symptoms, complex patterns in multidimensional data are analyzed to determine an outcome. The complexity of these patterns requires complex computing tools that have only recently been developed and that are sophisticated enough to discern patterns from such data. One such tool is based on the iData Analyzer software product for data analysis available from Information Acumen Corporation of Minneapolis, Minn.

As indicated above, there are a wide variety of physiological and/or external parameters that can be monitored by system 10. In some instances, it may be possible to reliably predict the onset of one or more symptoms in all individuals based on patterns determined from certain sensed data. That is, should data agent 12 measure certain levels or relationships between specific parameters, system 10 determines that there will be an onset of one or more symptoms, regardless of the individual being monitored. To the extent such cross-individual generalizations can be made, system 10 can utilize them and act upon them. However, in most cases the physiological parameters indicating the onset of one or more symptoms of interest will be unique to the individual patient, particularly if the system inputs include the patient's subjective experience of one or more symptoms. Thus, modeling agent 14 can be used to generate specific parameters relative to the particular patient utilizing system 10.

In summary, modeling agent 14 receives the biophysical output (patient state) data from data agent 12 along with the one or more symptom progression inputs made by (or for) the patient for a period of time. (As noted above, external state data may also be provided by data agent 12.) By analyzing and weighting the longitudinal/historical data, modeling agent 14 is able to establish criteria for predicting the onset of one or more symptoms of interest. In addition, modeling agent 14 can test system 10 over a period of time to determine the effectiveness and accuracy of the network parameters, and, when appropriate, make adjustments to improve the model. The result is a model (trained network) able to predict symptom onset when it is provided patient state data in real time. The iData Analyzer software product mentioned above includes software models that can be trained on properly normalized historical data and that, once trained, can receive real time inputs embodying patient state data and provide real time prediction outputs.

Controller agent 16 is a component responsible for acting upon a prediction by modeling agent 14 of the onset of symptoms. In one embodiment that may be useful when important biophysical data is received by the system that includes parameters outside the patient's consciousness, controller agent 16 simply alerts the patient. For example, a tone or beep may sound, a light may flash, a vibrating element may vibrate, or any other appropriate signal may be generated by indicator 15. Thus, the patient can be alerted ahead of time that symptoms will ensue and the patient can engage in or seek the proper preventative measures, such as a specific drug therapy or physical therapy or the like. In another embodiment, controller agent 16 alerts a doctor or other medical care giver that a patient is about to suffer from the onset of symptoms and the appropriate treatment can be administered. In another embodiment, controller agent 16 can be coupled with one or more drug delivery devices or resources 17 to automatically administer a dosage of medication (or coupled with any other appropriate drug, electrical stimulation or other interventional therapy) that addresses the one or more predicted symptoms. For example, controller agent 16 may include a transdermal drug delivery patch that may be electronically initiated. For example, a controlled release technique such as iontophoresis, piezoelectric control, or a micro-valve may be controlled by controller agent 16 to deliver an appropriate drug therapy at the appropriate time. With multiple drug delivering devices 17, drug therapies can be delivered to multiple locations and can be administered repeatedly over time, with or without varying the dosages. In addition, different drug therapies can be controlled and delivered with different protocols in combination by controller agent 16. Thus, any number of drug therapies can be delivered to one or more locations on the patient in patterns of varying complexity, as developed by network modeling.

In addition to predicting the onset of one or more symptoms, the neural network may also be trained to predict symptom alleviation resulting from medication or other therapy. Thus, with suitable training on data tracking biophysical parameters monitored after medication or other therapy commences, the present system may be used to shape the therapy protocol based on prediction of the extent of symptom alleviation. While adaptive drug delivery systems are known, e.g., U.S. Pat. No. 5,643,212, the present system is based on a predictive analysis.

B. Overview of Operation

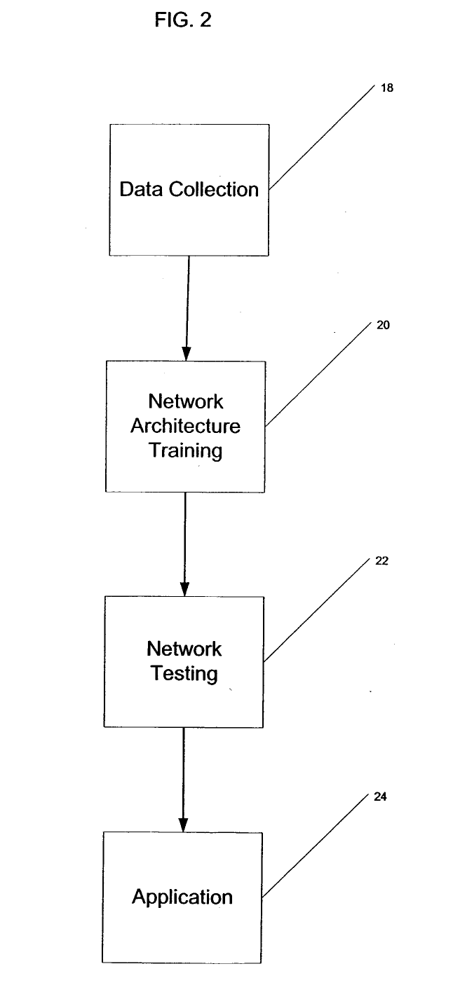

FIG. 2 is a flowchart indicating an overview of the operation of system 10. Broadly, system 10 may engage in data collection 18, network architecture training 20, network testing 22 and application 24 to establish and then utilize the proper network protocols.

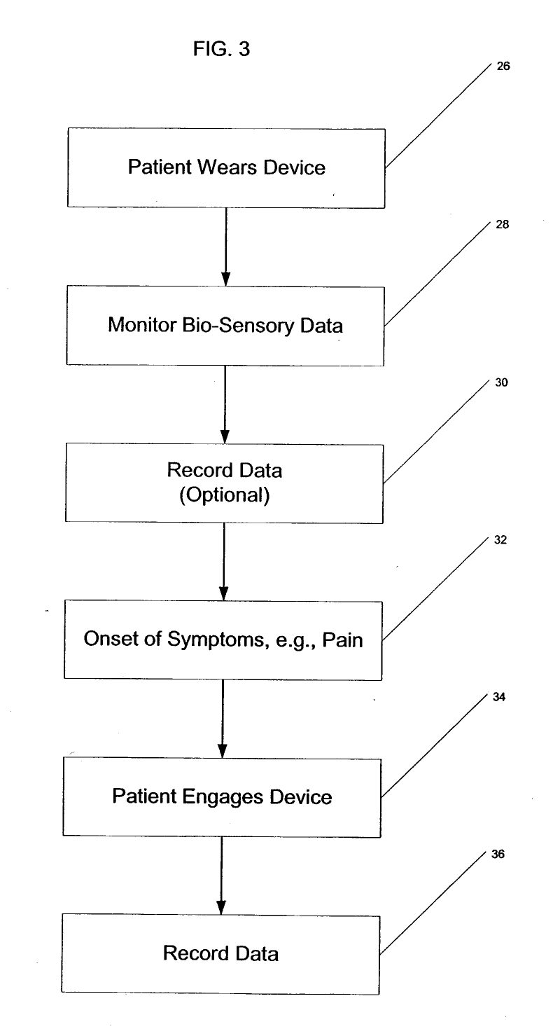

FIG. 3 is a flowchart illustrating one process useful for data collection 18. For a period of time, the patient will wear 26 (if appropriate) or otherwise engage data agent 12 so that the sensors incorporated therein can monitor the desired physiological (biophysical) characteristics of the patient, i.e., the patient state data, and the patient's surroundings, i.e., external state data, for the desired period. Data agent 12 monitors 28 the output of the various sensors during this period of time and may optionally record 30 this longitudinal data if desired. That is, having a full data set for a given period of time may be useful to the patient or medical personal for any number of potential reasons. For example, a person suffering from hypertension may have blood pressure readings taken over a longer period of time and at more frequent intervals, giving a more accurate indication of the condition than is possible from a measurement taken randomly in a doctor's office.

In one embodiment, at the onset of one or more symptoms 32, the patient manually provides input 34 to data agent 12 to indicate the presence and/or intensity of symptoms to system 10. The physiological data relevant to that episode of one or more symptoms is recorded 36 in memory. In other words, data is being collected about the patient that represents the physiological parameters that occur before and during the onset of symptoms so that this data can be modeled into a predictive network protocol. Thus, system 10 in one embodiment receives input from the patient that indicates when symptoms are actually occurring. In other embodiments there may be one or more biophysical parameters that sufficiently indicate the presence of a symptom, such that no subjective input from the patient is desired.

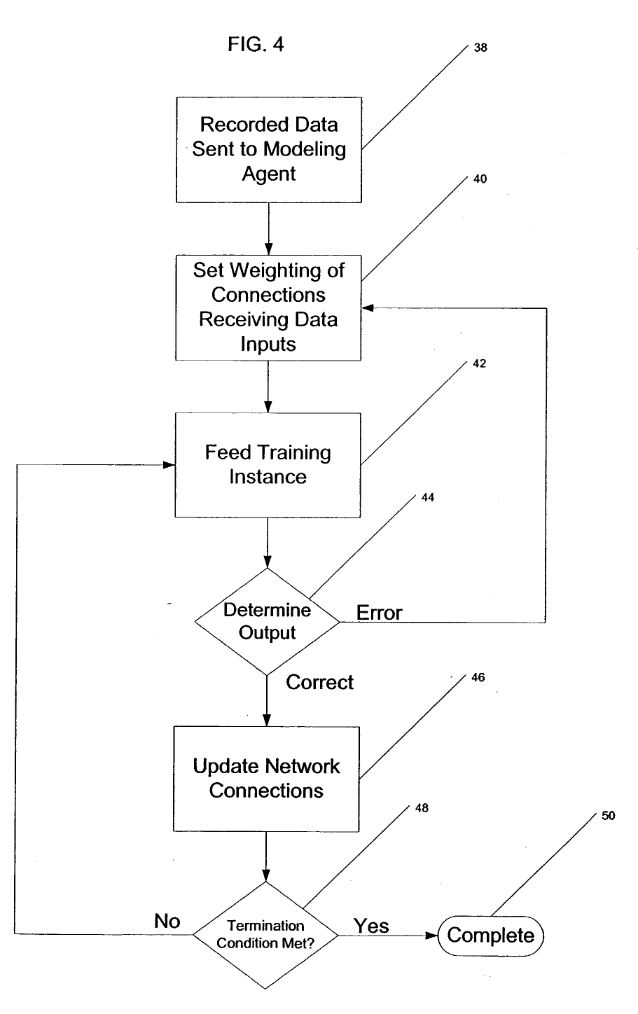

FIG. 4 is a flowchart indicating the process of network architecture training. The data recorded 36 is sent 38 (either as it is acquired or after a predetermined period of time) to modeling agent 14. Data transmission can be performed by a hardwired connection, such as connecting data agent 12 to a telephone line, device cradle, or computer interface or can occur via wireless communication means. Transmission may be to a local patient computer or to one remote from the patient. Once modeling agent 14 begins the process of establishing a network protocol, initial weighting must be assigned 40 to the various data inputs. These initial weighting values can be predetermined based on other uses of system 10 (i.e., previous patient data) or predictively estimated. In any event, the initial weights are set in the network connection layer. That is, data from various sensors is being (or will be) received by system 10. To be useful, a given data input should have some specific effect on the overall modeling process. For example, assume that prior to the onset of one or more symptoms of interest the patient pulse rate always increases beyond a specific level. This data is obviously relevant, however not necessarily determinative. That is, the pulse rate may be raised by exercise or any number of other factors. Thus, the data must be considered with respect to the various other sensory inputs, and this is referred to as the weighting of connections receiving data inputs. A value of importance is assigned to each data input, either individually or with respect to other data inputs.

The recorded data provided by the patient is then processed 42 by modeling agent 14 as a training instance and modeling agent 14 determines 44 if the onset of one or more symptoms of interest would have been predicted based upon the recorded physiological parameters. Of course, system 10 “knows” these parameters correlate to the onset of symptoms because the patient has so indicated this to system 10 or because the symptom of interest is unambiguously associated with certain physiological data. If there is an error and modeling agent 44 does not recognize the onset of one or more symptoms of interest, modeling agent 14 loops back and revises the weighting and other criteria 40 and reanalyzes the training instance. If modeling agent 14 correctly evaluated the training instance, modeling agent 14 then updates 46 the network parameters being established. The modeling agent 14 determines if a termination condition (i.e., all data analyzed, end of time period, etc.) has been reached 48. If it has, the network architecture training 20 is deemed complete 50. If the termination condition has not been met, another training instance is evaluated 42 and the process continues.

Once network architecture training 20 has been completed, network testing 22 may be conducted. That is, the patient is again involved in the process and manually indicates the onset of one or more symptoms, or the system monitors the data unambiguously associated with the symptom(s) of interest. Modeling agent 14 evaluates its own performance by comparing its predictive output with the patient provided (or system-sensed) symptom data to determine efficacy. If acceptable, system 10 is ready for use. If not acceptable, modeling agent 10 can repeat network architecture training 20 and may also repeat the initial data collection 18 to acquire new and/or additional data.

Ideally, the predictive power of the model is sufficient to afford the patient relief from all or most of the impact of the one or more undesired symptoms. That is, the prediction is made enough in advance of the undesired symptoms effects that a drug or other therapy can be introduced. If any delay in effectiveness of the drug or other therapy is present, then the predictive model is preferably trained to accommodate that time dimension in its prediction.

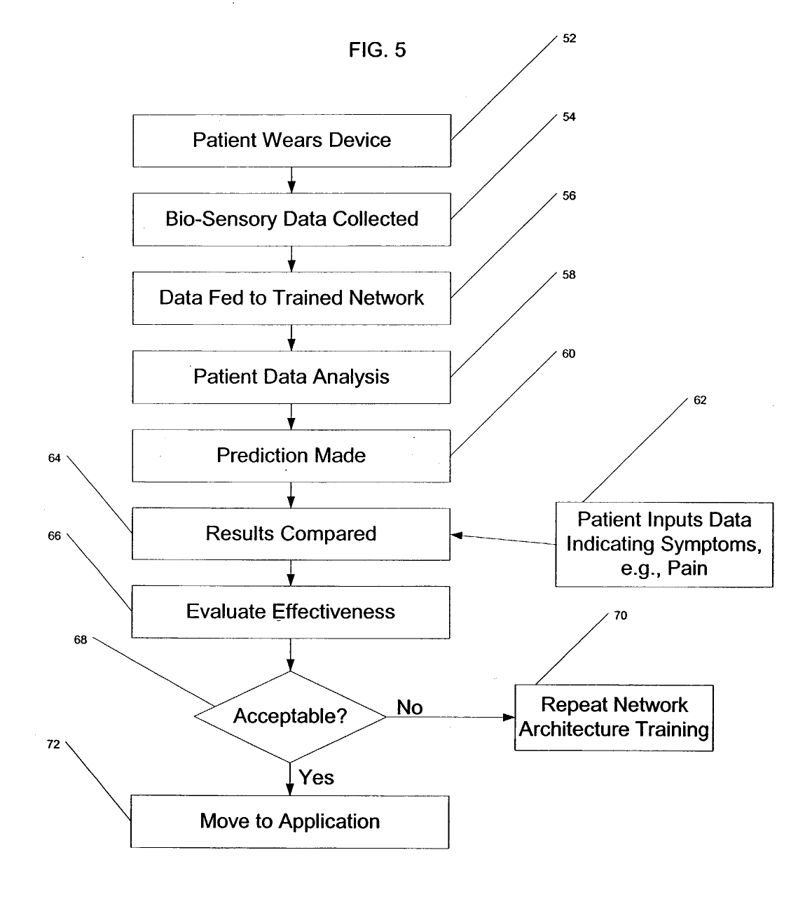

More specifically and with reference to FIG. 5, network testing 22 proceeds while the patient wears 52 or otherwise engages data collection agent 12 and the incorporated sensors collect 54 various physiological data that are fed 56 into modeling agent 14, which has a trained predictive network established. The data are then analyzed according to the established parameters 58 and predictions are made 60. For example, the model may predict that the patient is about to experience the onset of one or more symptoms of interest, such as a muscle spasm or a more subjective symptom, such as dizziness or pain. These predictions are compared 64 to the patient-provided data. That is, if the onset of one or more symptoms of interest are predicted, the patient should then manually enter 62 (or the system sensors detect) that symptoms have occurred and modeling agent 14 recognizes the correct prediction made by the network protocol. If not (assuming compliance by the patient) modeling agent 14 determines that the prediction was in error. To assure patient compliance during testing where symptoms are subjective, the patient can be queried when the onset of symptoms are predicted by modeling agent 14 so that patient error and forgetfulness is minimized.

These predictive outcomes are compared with patient perceived or sensor-measured symptom inputs and evaluated 68. If the error rate is unacceptable, network training may be repeated 70. If the network parameters are sufficiently accurate, system 10 can then be moved into the next stage of use 72, knowing that the predictive modeling for this patient is sufficiently accurate.

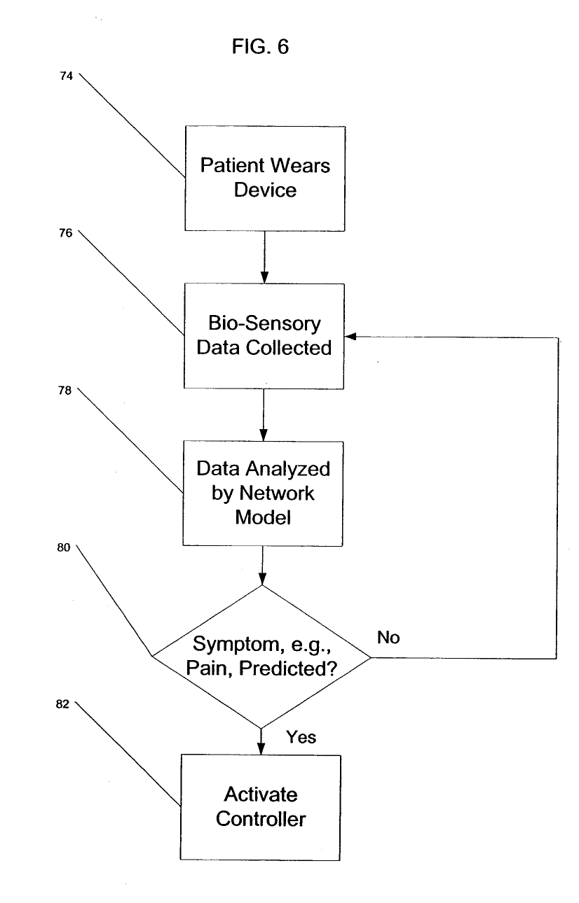

Once the network is accurately trained, in an embodiment where the modeling agent 14 is operably linked to a controller agent 16, the patient may begin to actually use the device for symptoms management of one or more symptoms, as represented in FIG. 6. Once again, the patient wears 74 or otherwise utilizes data agent 12 so that the various sensors can detect the required physiological parameters. Data agent 12 collects 76 the relevant data and that data is analyzed 78 by system 10 to determine if the onset of one or more symptoms are predicted based upon the recorded data and the predictive network parameters. Assuming symptoms are not predicted 80, system 10 simply continues to collect 76 and evaluate 78 the incoming patient data.

If symptoms are predicted 80, system 10 activates 82 controller agent 16 to initiate the proper response to symptoms. As explained above, this may simply be an indication to the patient to take medication or engage in other interventions to manage symptoms. Alternatively, it may actuate one or more drug delivery devices. In either case, the patient or the patient's care giver is able to anticipate the onset of symptoms and the patient can receive the appropriate therapy prior to the patient having to suffer the full impact of the symptoms.

C. System Diagrams

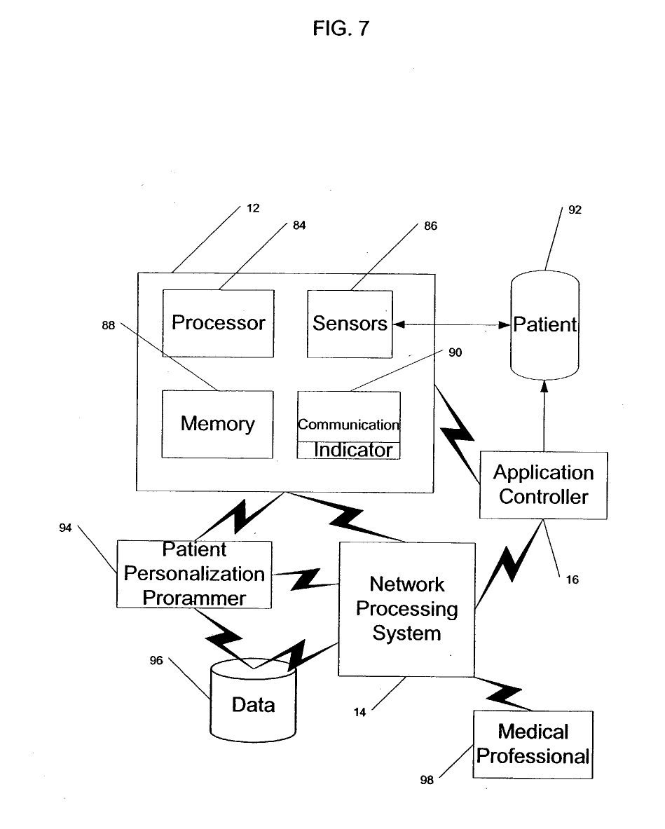

FIG. 7 is a system diagram illustrating one embodiment of system 10. Data agent 12 can take various forms and may be worn or carried near the patient 92 so that sensors 86 are appropriately positioned with respect to and if necessary, in contact with, the patient 92. In one embodiment, data agent 12 may be worn about the patient's wrist and one or more sensors 86 are in contact with the patient's skin. Data agent 12 may also include a processor 84 to operate and control the various components of data agent 12 and to receive and process the data generated by sensors 86. A memory 88 may be provided to record some or all of the data from sensors 86. Data agent 12 may be in communication with other components of system 10 and as such, an appropriate communication module 90 is provided. Communication module 90 can either communicate with other components via wireless communication protocols or may be linked to a hard wired data communication system such as a cradle, telephone line, network interface, personal computer communication port or similar components. Finally, communication module 90 may include a indicator to alert patient 92 to the predicted onset of one or more symptoms. The indicator can take various forms such as a display screen, light, speaker or similar component.

A network processing system or modeling agent 14 is illustrated as a separate component that could be in the form of a dedicated electronic device or may be a personal computer executing a specific software platform. In any event, network processing system 14 analyzes the data and establishes the appropriate predictive model. While illustrated as a separate component, network processing system 14 could be integrated into a single housing with data agent 12. A database 96 is provided that is accessible by network processing system 14.

A personalization programmer 94 may also be provided. Personalization programmer 94 may have functions that overlap or replace that of network processing system 14. That is, personalization programmer 94 may incorporate all of the data analysis and modeling functions in a smaller and more convenient hand held device.

In either case, the personalization programmer 94 or the network processing system 14 may optionally communicate with a medical professional 98 monitoring the patient's health for purposes of providing general information or for providing information specific to symptoms management.

The application controller 16 may be provided to deliver specific therapies, including various drug therapies to the patient 92, when the onset of symptoms are predicted. If no such function is to be provided, the indicator of communication module 90 may be sufficient without having a separate application controller 16.

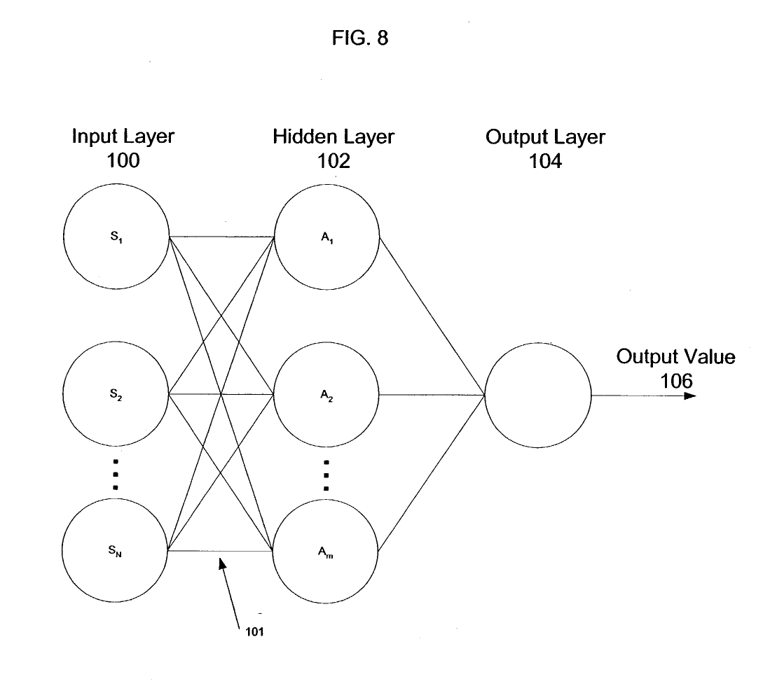

FIG. 8 illustrates the weighting values given to various sensory input parameters in a neural network model, wherein interconnected nodes imitate the functioning of the human brain. FIG. 8 represents a multi-layer fully connected feed-forward neural network that processes the data in order to predictively model the onset of symptoms. That is, the inputs S₁, S₂ . . . S_{N} from various sensors are introduced at the input layer 100 and pass through connections 101 to a hidden or internal analysis layer 102, wherein each sensor value is given a weighting value A₁, A₂ . . . Aₘ. Thus, the weighting of each sensor value can be varied and controlled, to produce at the output layer 104 the output value 106 derived from network analysis.

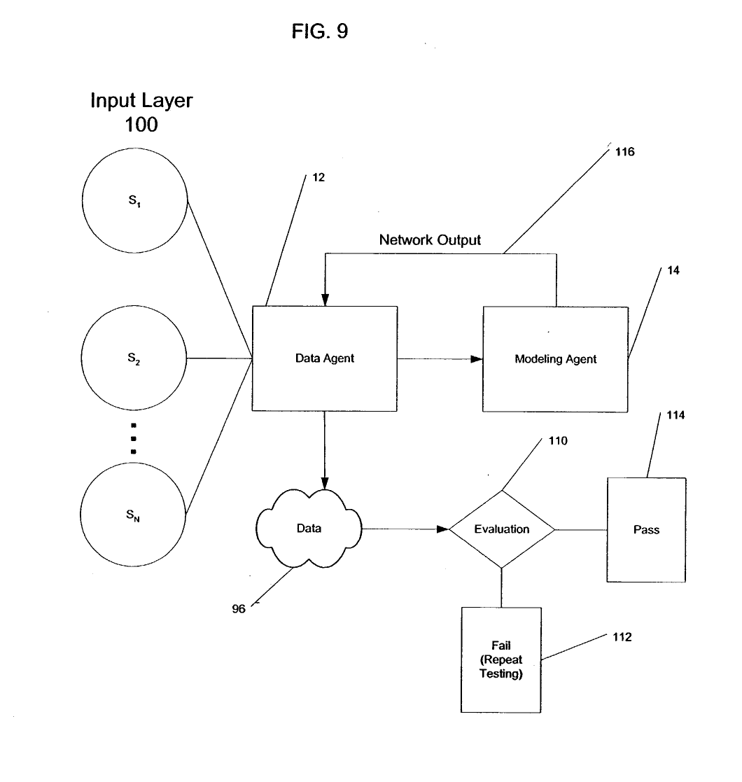

FIG. 9 is a system diagram indicating the process of network testing. Once again, data agent 12 receives data from sensors S₁, S₂ . . . S_{N} represented by input layer 100. The data is passed to modeling agent 14 which makes a predictive output 116, based on the stored data 96. An evaluation of the predictive outputs is made 110 and if passed 114, the system is implemented. If the prediction failed 112, the network protocols are revised.

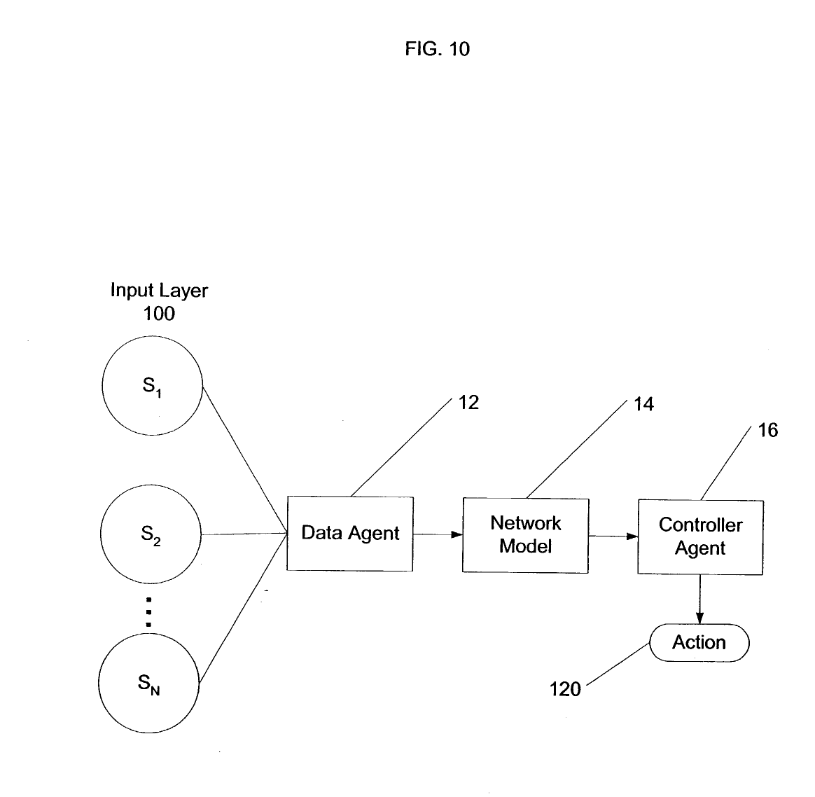

FIG. 10 is a system diagram illustrating data agent 12 receiving sensory data from input layer 100 in the sensors S₁, S₂ . . . S_{N} during use of system 10 by the patient, after the modeling process has established and tested the model parameters. That data is fed though the network model 14 and analyzed. Should the onset of symptoms be predicted, an indication is passed to controller agent 16 and the appropriate action 120 is taken.

D. Applications

To further illustrate how the invention may be used, an application relating to migraine headaches and an application relating to back pain are described.

Referring to FIG. 1, for an application addressing migraine headaches, the following sensors 13 may be used to collect data: blood pressure, heart rate, body temperature at extremities (such as skin temperature at a fingertip), and muscle tension on forehead, neck or other location viewed by the subject as affected by migraines. These data are sensed at intervals and stored in a time sequence.

Muscle tension can be measured at one or more points by a sensor that is linked to a transmitter to provide telemetry data to the Data Agent 12. Muscle tension can be measured by an electromyographic (EMG) signal reflecting motor activity. Research indicates that, under static conditions, there is a monotonous relation between muscle contraction level and the amount of EMG produced by the muscle. Research also indicates that the root mean square (RMS) value of the signal reflects the momentary degree of involvement of the muscle, whereas the spectral composition reflects localized muscle fatigue. Under prolonged static contraction, there is a general increase in EMG amplitude and a shift in the frequency spectrum from high to low frequencies, due to a decrease in the propagation velocity of the depolarization wave along the muscle fiber as fatigue sets in. (For a further discussion of muscle state measurement, see http://www.macses.ucsf.edu/Research/Allostatic/notebook/muscle.html).

For some patients, external state data such as barometric pressure or ambient temperature, humidity or light levels may also be sensed by sensors 13, particularly where a patient intuits that such factors may play a role in provoking migraine episodes.

In addition, for training of the modeling agent 14, it is useful to have symptom progression input to the data agent 12. The inputs can be separate for each subjective factor for which data is recorded or a single input device with means for distinguishing different types of input, e.g., a button with detection of duration of actuation. Patient subjective factors reported may include: irritability, tingling in extremities, vision affected by aura, nausea or vomiting, runny nose and watering eyes, skin sensitivity and appearance of the headache itself at lower, moderate and higher levels of pain. These data too are received over a period and stored in a time sequence, so as to be associated in time with the data from sensors 13.

Training of a neural network embodied in the modeling agent 14 results in a model for predicting occurrence of migraine headaches, based on the historical data sequences collected. In addition, it may result in evaluation of which data types are truly of predictive value (alone or in some combination with another item of sensor data). For a discussion of how a data set collected to describe some system behavior can be mined by the use of neural network training techniques to produce a trained neural network, see R. Roiger and M. Geatz, Data Mining—A Tutorial Based Primer (Addison Wesley 2003) and references cited therein.

The predictive model, once developed in modeling agent 14, preferably undergoes testing. By determining from testing whether the predictive model produces lower or higher levels of false positives or misses symptom situations that should have been predicted, the need for further training or model adjustment can be identified. Also it may be possible to develop confidence level or heuristic certainty factor measurements to be associated with prediction outputs of the neural network embodying the model. These may be used to tune the outputs of the model.

As shown in FIG. 1, the outputs of the modeling agent 14 are communicated to the controller agent 16. The controller agent may communicate a predictive output via an indicator 15. A simple indicator such as a light or buzzer may signal the predicted onset of a migraine headache. With a more complex indicator, such as a small display, the predictive outputs may include text or visual messages to patients or care givers, whereby a predictive warning is provided, qualified by a confidence level. The exact use of these confidence levels may depend on the consequences of false positives and missed episodes. False positives for a migraine might, for example, lead to over-medication or to unnecessary expense for medication that was not really needed. These consequences need to be balanced against the more subjective value of patient discomfort. The model and the controller agent can be adapted to provide the desired balance.

Once the predictive model for migraines is fully trained and tested with data from a particular patient, it can be deployed for a particular patient. (Typically the predictive model will be developed with data from and be used only for one patient; however, over time, more generalized models, applicable to certain patient populations may be found in the data.) With sufficient early warning of an impending migraine, the patient may be prompted or instructed to engage in a particular abortive therapy, to abort the migraine episode or the severest portions of it. The controller agent 16 may not only prompt but display instructions on the recommended medication, such as Imetrix, Emerge, Migrainal or Maxalt (all trademarks), and dosage. Alternatively, if the patient has biofeedback training, the patient may be prompted or instructed to engage in the biofeedback exercises to alleviate the migraine symptoms. The information displayed for the patient and caregiver may also be adapted to fit the particular patient. The display can indicate an intervention that is selected based on past experience and symptom alleviation reports of the patient to respond to the particular patients needs. The controller agent can have a menu of different display outputs, one or more of which may be selected based on the prediction model's analysis of the symptoms. For example, different medications might be indicated for different episodes, where historical data provide a basis for predicting different levels of intensity of symptoms. Alternatively, different levels of medications might be indicated depending on how soon the medication can be taken, e.g., take one tablet within ten minutes, take two tablets if medication is not available within one-half hour.

Referring again to FIG. 1, for an application addressing back pain, the following sensors 13 may be used to collect data: repetitive motion patterns (via accelerometers transmitting data from key body locations); blood pressure; heart rate; skin temperature at certain body points; and muscle tension in the neck, the upper back, lower back, hamstrings or other location viewed by the patient as affected directly or indirectly by the pain or known anatomically to be muscularly linked to the back. The latter can be measured at one or more points by EMG techniques discussed above, again with sensors linked to a transmitter to provide telemetry data to the Data Agent 12. As in the migraine case, these data are sensed at intervals over a period and stored in a time sequence.

In addition, for training of the modeling agent 14, it is useful to have subjective patient input to the data agent 12. For back pain, the subjective factors to be reported may include: muscle tightness, muscle spasm, numbness, tingling, shooting pains and appearance of the basic back pain symptom itself at lower, moderate and higher levels of pain. These data are received via patient input and stored in a time sequence, so as to be associated in time with the data from sensors 13.

Training of a neural network embodied in the modeling agent 14 results in a model for predicting occurrence of back pain, based on the data sequences collected by data agent 12. Known data mining techniques may be performed by neural networks resulting in predictive models This proceeds as described above for the migraine case with appropriate testing and determination of confidence or certainty levels. Again as shown in FIG. 1, the outputs of the modeling agent 14, now trained on back pain data, are communicated to the controller agent 16. The controller agent 16 may communicate a predictive output via an indicator 15. An indicator such as a light or buzzer could simply signal to the patient or an observer the predicted onset of a back pain. With a more complex indicator, such as a small display, the predictive outputs may include text or visual messages to a patient or an observer, whereby a predictive warning is provided, qualified by a confidence level. Alternatively, the display may have instructions for the patient to take some preventive action.

For some back pain, where the therapy is to alter physical activity, i.e., to change a position or to cease a particular activity of repeated motion, there is little serious danger from false positives and the system might be adjusted to provide early warnings with an increased risk of false positives. For chronic and more severe pain, the therapy might be prompting a patient to take an anti-inflammatory or pain relief drug. Here false positives may involve more critical effects of drugs and dosages and should be a greater factor in training, testing and adapting the prediction model in modeling agent 14.

In both migraine and back pain situations, it is anticipated that appropriate predictive models can lessen a patient's need for drugs or other interventions and/or cause the patient to use drugs at lower dosage levels. This should lead to less addiction, less development of drug tolerance and reduced drug side effects. In addition, early interventions often can limit the duration and/or severity of any episode experienced. Differences between patients can be accommodated both respect to training the prediction models where training is based on individual data

Although the present invention has been described with reference to various embodiments, persons skilled in the art will recognize that changes may be made in form and detail without departing from the spirit and scope of the invention and that various equivalents are possible within the spirit of the present invention.

We claim:

1. A method for predicting onset of a symptom in a patient comprising:
monitoring patient state data over a period of time and storing the monitored data;
providing at least a portion of the patient state data to a modeling agent and developing a predictive model for receiving patient state data collected in real time and evaluating such data to provide an output predicting the onset of the symptom; and
providing a controller agent for receiving and responding to the output predicting the onset of the symptom.

2. The method of claim 1 wherein the step of receiving and responding to the output predicting the onset of the symptom comprises providing an indicator to the patient or patient care giver.

3. The method of claim 1 wherein the step of receiving and responding to the output predicting the onset of the symptom comprises providing an indicator to the patient or patient care giver with an associated confidence level.

4. The method of claim 1 wherein the step of monitoring patient state data over a period of time and storing the monitored data comprises monitoring both biophysical data from sensors and symptom progression data reported by patient or patient observer input.

5. The method of claim 1 wherein the step of providing at least a portion of the patient state data to a modeling agent and developing a predictive model comprises providing the patient state data to a neural network and training the neural network to predict symptom onset.

6. The method of claim 1 wherein the step of receiving and responding to the output predicting the onset of the symptom comprises providing control signals to a drug delivery device.

7. The method of claim 1 further comprising the step of monitoring external state data over a period of time, storing the monitored external state data in association with the patient state data and providing at least a portion of the external state data to the modeling agent.

8. A system for predicting onset of a symptom in a patient comprising:
a data agent comprising at least one sensor for monitoring and storing historical patient state data;
a modeling agent for establishing and testing a predictive model based on such historical patient state data, by which patient state data collected in real time are evaluated to predict the onset of the symptom; and
a controller agent communicating with the modeling agent for responding to a predicted onset of the symptom.

9. The system of claim 8, wherein the symptom is an indication for a medical condition.

10. The system of claim 8, wherein the data agent comprises a plurality of sensors for monitoring patient state data.

11. The system of claim 8, wherein the data agent monitors and stores at least one symptom progression parameter communicated by the patient or a patient care giver.

12. A system for predicting onset of a symptom in a patient comprising:
a data agent that receives and stores for a period of time patient state inputs from two or more sensors, including physiological parameters of the patient, to create historical patient state data;
a modeling agent for establishing a predictive model based on historical patient state data, said predictive model producing in response to real time patient state data at least one predictive output signaling the onset of the symptom; and
a controller agent responsive to the at least one predictive output to initiate an intervention.

13. The system of claim 12 wherein the data agent receives as part of the historical patient state data symptom progression data.

14. The system of claim 12 wherein the data agent receives as part of the historical patient state data patient-reported symptom progression data.

15. The system of claim 12 wherein the controller agent has a display for indicating an intervention to be taken in response to the at least one predictive output.

16. The system of claim 12 further comprising a drug delivery resource responsive to the controller agent to provide a drug delivery intervention in response to the at least one predictive output.

17. A system as claimed in claim 12 wherein the symptom subject to prediction is migraine headache and the patient state inputs comprise: blood pressure, heart rate, body temperature at at least one extremity, and muscle tension of at a least one body location.

18. A system as claimed in claim 12 wherein the symptom subject to prediction is back pain and the patient state inputs comprise: repetitive motion pattern data, blood pressure, heart rate, and muscle tension of at least one body location in or muscularly linked to the back.

19. A system as claimed in claim 12 wherein the modeling agent for establishing a predictive model comprises a neural network.

20. A system as claimed in claim12 wherein the modeling agent for establishing a predictive model comprises a feed forward neural network with back-propagation learning features.

21. A system as claimed in claim 12 wherein the modeling agent for establishing a predictive model comprises a software model with genetic learning features.
